(19) United States
(12) Patent Application Publication
(10) Pub. No.: US 2023/0107852 A1
(43) Pub. Date: Apr. 6, 2023

(54) MOVE ESTIMATION DEVICE, MOVE ESTIMATION METHOD, AND MOVE ESTIMATION PROGRAM

(71) Applicant: NIPPON TELEGRAPH AND TELEPHONE CORPORATION, Tokyo (JP)

(72) Inventors: Yasunori AKAGI, Tokyo (JP); Takuya NISHIMURA, Tokyo (JP); Takeshi KURASHIMA, Tokyo (JP); Hiroyuki TODA, Tokyo (JP)

(73) Assignee: NIPPON TELEGRAPH AND TELEPHONE CORPORATION, Tokyo (JP)

(21) Appl. No.: 17/767,414

(22) PCT Filed: Oct. 8, 2019
(86) PCT No.: PCT/JP2019/039665

§ 371 Date: Apr. 7, 2022

(51) Int. Cl. G06V 20/52

(52) U.S. Cl. CPC G06V 20/52; G06T 2207/30

(57) ABSTRACT

An object is to make it possible to accurately estimate the number of movements at a high speed. A generation unit (130) generates an optimization problem for estimating, with respect to each of a plurality of areas, the number of observation targets that move from the area to each of the other areas at each observation time point, as the number of movements, based on observation values and movement probabilities, the observation values indicating, with respect to each area, the number of observation targets that are present in the area at each observation time point, and the movement probabilities indicating, with respect to each area, probabilities of movement from the area to the other areas at each observation time point. A first estimation unit (140) estimates the number of movements by solving the generated optimization problem using a Sinkhorn-Knopp algorithm. A second estimation unit (160) estimates the movement probabilities based on the observation values and the estimated number of movements. An estimation control unit (120) repeats generation of the optimization problem, estimation of the number of movements, and estimation of the movement probabilities until a condition determined in advance is satisfied.

### TECHNICAL FIELD

The present disclosure relates to a movement estimation device, a movement estimation method, and a movement estimation program.

### BACKGROUND ART

Conventionally, there are needs for estimating the number of movements between areas between observation time points from observation values that indicate the number of observation targets that are present in each area at each observation time point (time step). For example, there is a need for estimating the number of moved people in a case where the observation targets are people.

In conventional technologies, the probability of movement and the number of movements between areas are estimated using a framework (Collective Graphical Model) in which an individual probability model is estimated from collected observation values (NPL 1, NPL 2). In the conventional technologies, the number of movements is estimated by maximizing a likelihood function L(M,θ) that is calculated from the number of movements Mₜᵢⱼ from an area i to an area j between an observation time point t and an observation time point t+1 and the probability θᵢⱼ of movement from the area i to the area j, by alternately moving M and θ under constraints of conservation of observation values.

### CITATION LIST

### Non Patent Literature

[NPL 1] D. R. Sheldon and T. G. Dietterich. Collective Graphical Models. In Proceedings of the 24th International Conference on Neural Information Processing Systems, 2011, pp. 1161-1169.
[NPL 2] Y. Akagi, T. Nishimura, T. Kurashima, H. Toda, “A Fast and Accurate Method for Estimating People Flow from Spatiotemporal Population Data”, Proceedings of the 27th International Joint Conference on Artificial Intelligence and the 23rd European Conference on Articial Intelligence(IJCAI-ECAI-2018), 2018, pp. 3293-3300.

### SUMMARY OF THE INVENTION

### Technical Problem

However, in the conventional methods, a convex optimization problem that includes an enormous number of variables needs to be solved to optimize M, and there is a problem in that the calculation takes time.

A technology disclosed herein was conceived in view of the foregoing, and has an object of providing a movement estimation device, a movement estimation method, and a movement estimation program that make it possible to accurately estimate the number of movements at a high speed.

### Means for Solving the Problem

A first aspect of the present disclosure is a movement estimation device including: a generation unit; a first estimation unit; a second estimation unit; and an estimation control unit, wherein the generation unit generates an optimization problem for estimating, with respect to each of a plurality of areas, the number of observation targets that move from the area to each of the other areas at each observation time point, as the number of movements, based on observation values and movement probabilities, the observation values indicating, with respect to each of the plurality of areas, the number of observation targets that are present in the area at each observation time point, and the movement probabilities indicating, with respect to each of the plurality of areas, probabilities of movement from the area to the other areas at each observation time point; the first estimation unit estimates the number of movements by solving the optimization problem generated by the generation unit, using a Sinkhorn-Knopp algorithm, the second estimation unit estimates the movement probabilities based on the observation values and the number of movements estimated by the first estimation unit, and the estimation control unit repeats processing performed by the generation unit, the first estimation unit, and the second estimation unit until a condition determined in advance is satisfied.

A second aspect of the present disclosure is a movement estimation method including: generating, by a generation unit, an optimization problem for estimating, with respect to each of a plurality of areas, the number of observation targets that move from the area to each of the other areas at each observation time point, as the number of movements, based on observation values and movement probabilities, the observation values indicating, with respect to each of the plurality of areas, the number of observation targets that are present in the area at each observation time point, and the movement probabilities indicating, with respect to each of the plurality of areas, probabilities of movement from the area to the other areas at each observation time point; estimating, by a first estimation unit, the number of movements by solving the optimization problem generated by the generation unit, using a Sinkhorn-Knopp algorithm; estimating, by a second estimation unit, the movement probabilities based on the observation values and the number of movements estimated by the first estimation unit; and repeating, by an estimation control unit, processing performed by the generation unit, the first estimation unit, and the second estimation unit until a condition determined in advance is satisfied.

A third aspect of the present disclosure is a movement estimation program for causing a computer to: generate, by a generation unit, an optimization problem for estimating, with respect to each of a plurality of areas, the number of observation targets that move from the area to each of the other areas at each observation time point, as the number of movements, based on observation values and movement probabilities, the observation values indicating, with respect to each of the plurality of areas, the number of observation targets that are present in the area at each observation time point, and the movement probabilities indicating, with respect to each of the plurality of areas, probabilities of movement from the area to the other areas at each observation time point; estimate, by a first estimation unit, the number of movements by solving the optimization problem generated by the generation unit, using a Sinkhorn-Knopp algorithm; estimate, by a second estimation unit, the movement probabilities based on the observation values and the number of movements estimated by the first estimation unit; and repeat, by an estimation control unit, processing performed by the generation unit, the first estimation unit, and the second estimation unit until a condition determined in advance is satisfied.

### Effects of the Invention

According to the disclosed technology, the number of movements can be accurately estimated at a high speed.

### BRIEF DESCRIPTION OF DRAWINGS

FIG. 1 is a diagram showing a Sinkhorn-Knopp algorithm.

FIG. 2 is a block diagram showing a schematic configuration of a computer that functions as a movement estimation device.

FIG. 3 is a block diagram showing an example of a functional configuration of the movement estimation device.

FIG. 4 is a diagram showing an example of area population data of each time point.

FIG. 5 is a diagram showing an example of the number of moved people.

FIG. 6 is a diagram showing an example of movement probabilities.

FIG. 7 is a flowchart showing a movement estimation processing routine of the movement estimation device.

FIG. 8 is a diagram showing a Sinkhorn-Knopp algorithm.

### DESCRIPTION OF EMBODIMENTS

Overview of Movement Estimation Device According to Embodiment of the Present Disclosure

First, an overview of an embodiment of the present disclosure will be described. In the embodiment of the present disclosure, a case where observation targets are people will be described as an example. That is, the following describes a case where the number of people who move between areas between observation time points is estimated from area population data of each time point. The area population data of each time point is information that indicates the number (observation value) of people who are present in each area at each observation time point (time step). It is assumed that the areas are defined by dividing a geographical space in the manner of a grid, for example. In particular, there are needs for estimating the number of moved people, because position information regarding people obtained from a GPS or the like is provided as area population data of each time point that does not enable tracking of individuals in view of privacy.

In the embodiment of the present disclosure, a Sinkhorn-Knopp algorithm is used when estimating the number of moved people in order to improve the estimation speed of conventional technologies for estimating the number of moved people and to eliminate a hyperparameter.

The Sinkhorn-Knopp algorithm is an algorithm for finding nonnegative diagonal matrices R and C such that Y=RXC, Y1ₘ=r, and Y^{T}1ₙ=c are satisfied, when a nonnegative matrix X∈R^{n×m} and probability vectors r∈Rⁿ and c∈R^{m} are given. By appropriately transforming this problem and generating an optimization problem, the algorithm can be applied to update M.

Overview of Estimation Process Performed by Movement Estimation Device According to Embodiment of the Present

### DISCLOSURE

Next, an overview of an estimation process that is performed by the movement estimation device according to the embodiment of the present disclosure will be described.

First, symbols are defined as follows.

k: Natural number, [k]:={1, . . . , k}.
V: Set of all areas.
T: Maximum value of time step. That is, time steps are: t=1, . . . , T.
G=(V,E): Undirected graph representing an adjacency relationship between areas.
Γᵢ: Set of areas to which people can move from an area i.
Nₜᵢ: The number of people present in the area i at a time point t. Nₜᵢ(t∈[T], i∈V).
Mₜᵢⱼ: The number of people moved from the area i to an area j between the time point t and a time point t+1. Mₜᵢⱼ(t∈[T−1], i,j∈V).

Description of Conventional Technology

Next, a conventional technology will be described.

Assume that the number Mₜᵢ={Mₜᵢⱼ|j∈V} of people who move from the area i at the time point t is generated using a probability expressed by the following formula (1) using a probability θᵢ={θᵢⱼ|j∈Γᵢ} of movement from the area i, where θᵢⱼ represents the probability of movement from the area i to the area j.

$$\begin{matrix}[ Math . 1 ] & \\ P ( {M}_{ti} \vert {N}_{ti} , {θ}_{i} ) = \frac{{N}_{ti} !}{{\prod }_{j ∈ {Γ}_{t}} {M}_{tij} !} {\prod }_{j ∈ {Γ}_{t}} {θ}_{ij}^{{M}_{tij}} & ( 1 )\end{matrix}$$

Accordingly, when N={Nₜᵢ|t∈[T], i∈V} and θ={θᵢ|i∈V} are given, a likelihood function of M={Mₜᵢ|t∈[T−1],i∈V} is the following formula (2).

$$\begin{matrix}[ Math . 2 ] & \\ P ( M \vert N , θ ) = {\prod }_{t ∈ [ T - 1 ]} {\prod }_{i ∈ V} ( \frac{{N}_{ti} !}{{\prod }_{j ∈ {Γ}_{t}} {M}_{tij} !} {\prod }_{j ∈ {Γ}_{t}} {θ}_{ij}^{{M}_{tij}} ) & ( 2 )\end{matrix}$$

Also, constraints expressed by the following formulas (3) and (4) that represent a conservation law of the number of people hold true.

[Math. 3]

Nₜᵢ=Σ_{j∈Γ}_{ₜ}Mₜᵢⱼ(t∈[T−1],i∈V) (3)

N_{t+1,i}=Σ_{j∈Γ}_{ₜ}Mₜᵢⱼ(t∈[T−1],i∈V) (4)

The number of moved people is estimated by minimizing a negative log likelihood function expressed by the following formula (5) under the above constraints (3) and (4).

$$\begin{matrix}[ Math . 4 ] & \\ - log P ( M \vert M , θ ) = - {\sum }_{t ∈ [ T - 1 ]} {\sum }_{i ∈ V} ( log {N}_{ti} ! - {\sum }_{j ∈ {Γ}_{t}} {M}_{tij} ! + {\sum }_{j ∈ {Γ}_{t}} {M}_{tij} log {θ}_{ij} ) & ( 5 )\end{matrix}$$

$$= - {\sum }_{t ∈ [ T - 1 ]} {\sum }_{i ∈ V} {\sum }_{j ∈ {Γ}_{t}} ( log {M}_{tij} ! - {M}_{tij} log {θ}_{ij} ) + const .$$

That is, an optimization problem that is to be solved is the following formula (6).

[Math. 5]

minimize_{M,θ}Σ_{t∈[T-1}]Σ_{i∈V}Σ_{j∈Γ}_{ₜ}(log Mₜᵢⱼ!−Mₜᵢⱼ log θᵢⱼ), (6a)

subject to Nₜᵢ=Σ_{j∈Γ}_{ₜ}Mₜᵢⱼ(t=0,1, . . . ,T−2), (6b)

N_{t+1,i}=Σ_{j∈Γ}_{ₜ}Mₜⱼᵢ(t∈[T−1],i∈V) (6c)

Σ_{j∈Γ}_{ₜ}θᵢⱼ=1(t∈[T−1],i∈V) (6d)

0≤θᵢⱼ≤1(i,j∈V) (6e)

Mₜᵢⱼ∈ [symbol] _{≥0} (6f)

Z in the above formula (6f) (outlined Z in formula (6f)) represents a set of all integers greater than or equal to 0. A likelihood function L(M,θ) is minimized by alternately performing minimization with respect to M and θ.

The minimization with respect to M is performed as follows. First, continuous relaxation is performed with respect to M, and Stirling's approximation is applied to the term of log Mₜᵢⱼ! to transform the objective function as shown by the following formula (7).

[Math. 6]

Σ_{t∈[T-1]}Σ_{i∈V}Σ_{j∈Γ}_{ₜ}(Mₜᵢⱼ log Mₜᵢⱼ−Mₜᵢⱼ−Mₜᵢⱼ log θᵢⱼ) (7)

Furthermore, the above-described constraints (6b) and (6c) regarding conservation of the number of people are incorporated as penalties into the objective function as shown in the following formula (8).

$$\begin{matrix}[ Math . 7 ] & \\ {\sum }_{t ∈ [ T - 1 ]} {\sum }_{i ∈ V} {\sum }_{j ∈ {Γ}_{t}} ( {M}_{tij} log {M}_{tij} - {M}_{tij} - {M}_{tij} log {θ}_{ij} ) & ( 8 )\end{matrix}$$

$$- \frac{λ}{2} \cdot {\sum }_{t ∈ [ T - 1 ]} {\sum }_{i ∈ V} {( {N}_{ti} - {\sum }_{j ∈ {Γ}_{t}} {M}_{tij} )}^{2} - \frac{λ}{2} \cdot {\sum }_{t ∈ [ T - 1 ]} {\sum }_{i ∈ V} {( {N}_{t + 1 , i} - {\sum }_{j ∈ {Γ}_{t}} {M}_{tji} )}^{2}$$

In the above formula (8), λ represents a parameter for controlling the penalties. The objective function expressed by the above formula (8) is minimized under the following constraint: Mₜᵢⱼ≥0. This is a convex programming problem, and accordingly, a global optimal solution can be found using an L-BFGS-B method or the like.

Also, maximization with respect to θ is performed using Lagrange's method of undetermined multiplier or the like. By minimizing the likelihood function L(M,θ) by alternately moving M and θ under the constraints regarding conservation of observation values, the number of moved people is estimated.

Overview of Estimation Process

Next, an overview of the estimation process will be described.

First, an optimization problem for estimating the number of moved people is generated by combining currently estimated movement probabilities and area population data of each time point. More specifically, M can be updated by solving an optimization problem expressed by the following formula (9) independently for t∈[T−2].

$$\begin{matrix}[ Math . 8 ] & \\ {min}_{{M}_{t}} . {\sum }_{i ∈ V} {\sum }_{j ∈ {Γ}_{t}} ( log {M}_{tij} ! - {M}_{tij} log {θ}_{ij} ) , & ( 9 )\end{matrix}$$

$$s . t . {N}_{ti} = {\sum }_{j ∈ {Γ}_{t}} {M}_{tij} ( i ∈ V ) ,$$

$${N}_{t + 1 , i} = {\sum }_{j ∈ {Γ}_{t}} {M}_{tji} ( i ∈ V ) ,$$

$${M}_{tij} ∈ = {ℤ}_{\geq 0} ( i ∈ V , j ∈ {Γ}_{i} )$$

Preprocessing is performed in advance such that Σᵢ_{^{∈}}_{V}N_{t,i}=Σᵢ_{^{∈}}_{V}N_{t+1,i} holds true. The preprocessing can be realized by adding a virtual area v, and letting Nt,v=Σᵢ_{^{∈}}_{V}N_{t+1,i}−Σᵢ_{^{∈}}_{V}N_{t,i} and N_{t+1,v}=0 hold true in a case where Σᵢ_{^{∈}}_{V}N_{t,i}<Σᵢ_{^{∈}}_{V}N_{t+1,i}, and letting Nt,v=Σᵢ_{^{∈}}_{V}N_{t,i}−Σᵢ_{^{∈}}_{V}N_{t+1,i} and N_{t,v}=0 hold true in a case where Σᵢ_{^{∈}}_{V}N_{t,i}>Σᵢ_{^{∈}}_{V}N_{t+1,i}. After the preprocessing is performed, F is defined as follows: F=Σᵢ_{^{∈}}_{V}N_{t,i}=Σᵢ_{^{∈}}_{V}N_{t+1,i}.

Next, Stirling's approximation shown below is applied to an objective function of the optimization problem expressed by the above formula (9) and continuous relaxation is performed with respect to Mₜᵢⱼ to obtain an optimization problem expressed by the following formula (10).

$$log {M}_{tij} ! \approx {M}_{tij} log {M}_{tij} - {M}_{tij}$$

$$\begin{matrix}[ Math . 9 ] & \\ {min}_{{M}_{t}} . {\sum }_{i ∈ V} {\sum }_{j ∈ {Γ}_{t}} ( {M}_{tij} log {M}_{tij} - {M}_{tij} log {θ}_{ij} ) , & ( 10 )\end{matrix}$$

$$s . t . {N}_{ti} = {\sum }_{j ∈ {Γ}_{t}} {M}_{tij} ( i ∈ V ) ,$$

$${N}_{t + 1 , i} = {\sum }_{j ∈ {Γ}_{t}} {M}_{tji} ( i ∈ V ) ,$$

$${M}_{tij} ∈ = {ℤ}_{\geq 0} ( i ∈ V , j ∈ {Γ}_{i} )$$

The term of Σᵢ_{^{∈}}_{V}Σⱼ_{^{∈}}_{Γ}Mₜᵢⱼ in the objective function is a constant due to the constraints, and therefore is omitted.

Here, the optimization problem expressed by the above formula (10) is converted to the following formula (12) using the following formula (11).

$$\begin{matrix}[ Math . 10 ] & \\ {m}_{ij} := \frac{{M}_{tij}}{F} , {r}_{i} = \frac{{N}_{t , i}}{F} , {c}_{i} = \frac{{N}_{t + 1 , i}}{F} & ( 11 )\end{matrix}$$

$$\begin{matrix}[ Math . 11 ] & \\ {min}_{m} . {\sum }_{i ∈ V} {\sum }_{j ∈ {Γ}_{t}} {m}_{ij} ( log {m}_{tij} - log {θ}_{ij} ) , & ( 12 )\end{matrix}$$

$$s . t . {r}_{i} = {\sum }_{j ∈ {Γ}_{t}} {m}_{ij} ( i ∈ V ) ,$$

$${c}_{i} = {\sum }_{j ∈ {Γ}_{t}} {m}_{ji} ( i ∈ V ) ,$$

$${m}_{ij} ∈ = {ℝ}_{\geq 0} ( i ∈ V , j ∈ {Γ}_{i} )$$

The optimization problem expressed by the above formula (12) is the optimization problem for estimating the number of moved people according to the embodiment of the present disclosure. Hereinafter, this optimization problem will be simply referred to as a problem (12).

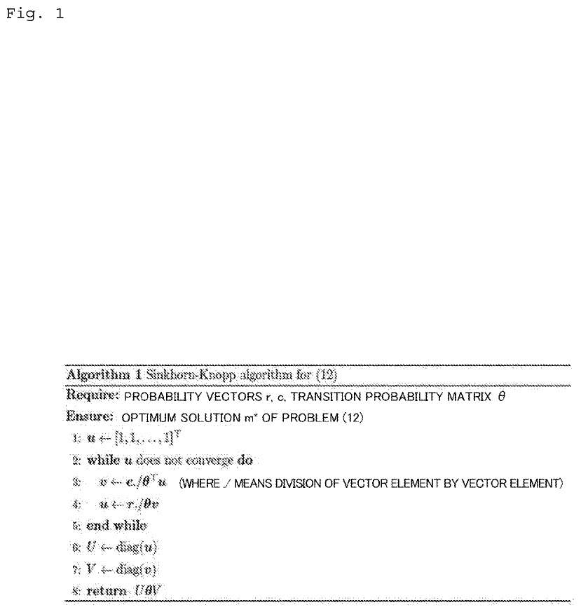

Second, the number of moved people is estimated by solving the problem (12) using a Sinkhorn-Knopp algorithm. The problem (12) corresponds to a problem of finding Sinkhorn divergence (Reference Document 1) between a probability vector r and a probability vector c when a regularization parameter Z is equal to 1 and a cost function is log θᵢⱼ. This problem can be solved using a Sinkhorn-Knopp algorithm (Reference Document 2) written in an algorithm 1 shown in FIG. 1.
[Reference Document 1] M. Cuturi, Sinkhorn Distances: Lightspeed Computation of Optimal Transport. In Proceedings of the 26th International Conference on Neural Information Processing Systems, 2013, pp. 2292-2300.
[Reference Document 2] P. A. Knight, The Sinkhorn-Knopp Algorithm: Convergence and Applications. In SIAM J. Matrix Anal. Appl., 30(1), 261-275.

Third, movement probabilities are estimated based on area population data of each time point and the currently estimated number of moved people. The logarithm of the likelihood P(M|N,θ) is expressed by the following formula (13).

$$\begin{matrix}[ Math . 12 ] & \\ log P ( M \vert N , θ ) = {\sum }_{t ∈ [ T - 1 ]} {\sum }_{i ∈ V} ( log {N}_{ti} ! - {\sum }_{j ∈ {Γ}_{t}} log {M}_{tij} ! + {\sum }_{j ∈ {Γ}_{t}} {M}_{tij} log {θ}_{ij} ) & ( 13 )\end{matrix}$$

$$= {\sum }_{t ∈ [ T - 1 ]} {\sum }_{i ∈ V} {\sum }_{j ∈ {Γ}_{t}} {M}_{tij} log {θ}_{ij} + const .$$

In the last line of the above formula (13), terms other than that depends on θ are taken to be constants and are omitted.

By maximizing log P(M|N,θ) under the following constraints, θ* is obtained.

Σ_{j∈Γ}_{ᵢ}θᵢⱼ=1(i∈V),0≤θᵢⱼ≤1(i,j∈V)

θ* can be described in a closed form shown by the following formula (14) using Lagrange's method of undetermined multiplier.

$$\begin{matrix}[ Math . 13 ] & \\ {θ}_{ij}^{*} = \frac{{\sum }_{t ∈ [ T - 1 ]} {M}_{tij}}{{\sum }_{t ∈ [ T - 1 ]} {\sum }_{k ∈ {Γ}_{t}} {M}_{tik}} & ( 14 )\end{matrix}$$

Fourth, the first to third processing is repeated until a condition determined in advance is satisfied. The condition determined in advance is, for example, “the likelihood has converged” or “the processing has been repeated a predetermined number of times”.

The above is an overview of the estimation process of the movement estimation device according to the embodiment of the present disclosure.

Configuration of Movement Estimation Device According to Embodiment of Technology of the Present Disclosure

The following describes an exemplary embodiment of the disclosed technology with reference to the drawings. In the drawings, the same or equivalent constitutional elements and portions are denoted with the same reference signs. Dimensional ratios shown in the drawings are exaggerated for the sake of convenience of description, and may differ from actual ratios.

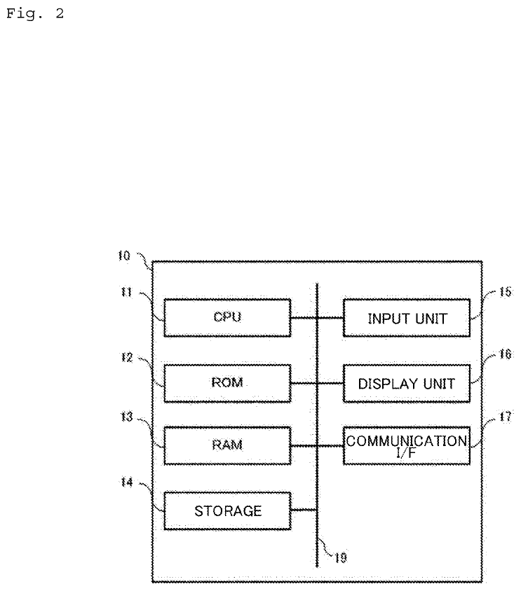

FIG. 2 is a block diagram showing a hardware configuration of a movement estimation device 10 according to the present embodiment. As shown in FIG. 2, the movement estimation device 10 includes a CPU (Central Processing Unit) 11, a ROM (Read Only Memory) 12, a RAM (Random Access Memory) 13, a storage 14, an input unit 15, a display unit 16, and a communication interface (I/F) 17. The constitutional elements are communicably connected to each other via a bus 19.

The CPU 11 is a central processing unit and executes various programs and controls each unit. That is, the CPU 11 reads programs from the ROM 12 or the storage 14 and executes the programs using the RAM 13 as a work area. The CPU 11 controls the constitutional elements described above and performs various types of computation processing, following programs stored in the ROM 12 or the storage 14. In the present embodiment, a movement estimation program for executing movement estimation processing is stored in the ROM 12 or the storage 14.

Various programs and various types of data are stored in the ROM 12. A program or data is temporarily stored in the RAM 13 that serves as a work area. The storage 14 is constituted by a storage device such as a HDD (Hard Disk Drive) or a SSD (Solid State Drive), and various programs including an operating system and various types of data are stored in the storage 14.

The input unit 15 includes a pointing device such as a mouse and a keyboard, and is used for various types of input.

The display unit 16 is a liquid crystal display, for example, and displays various types of information. A touch panel system may also be adopted so that the display unit 16 also functions as the input unit 15.

The communication interface 17 is an interface for communicating with other devices, and a standard such as Ethernet (registered trademark), FDDI, or Wi-Fi (registered trademark) is used, for example.

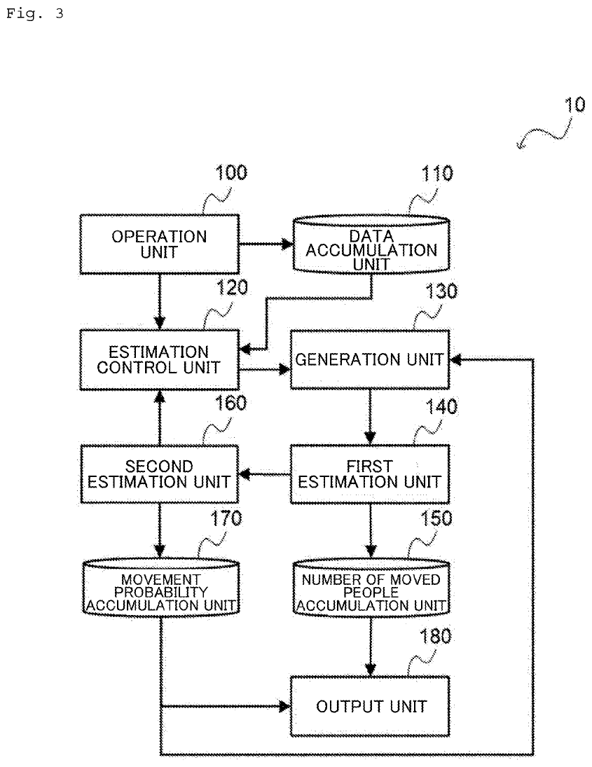

Next, a functional configuration of the movement estimation device 10 will be described. FIG. 3 is a block diagram showing an example of the functional configuration of the movement estimation device 10.

As shown in FIG. 3, the movement estimation device 10 includes, as functional units, an operation unit 100, a data accumulation unit 110, an estimation control unit 120, a generation unit 130, a first estimation unit 140, a number of moved people accumulation unit 150, a second estimation unit 160, a movement probability accumulation unit 170, and an output unit 180. Each functional unit is realized as a result of the CPU 11 reading the movement estimation program stored in the ROM 12 or the storage 14, loading the program into the RAM 13, and executing the program.

The operation unit 100 accepts various operations with respect to data stored in the data accumulation unit 110. More specifically, the various operations are operations for registering, correcting, or deleting area population data of each time point.

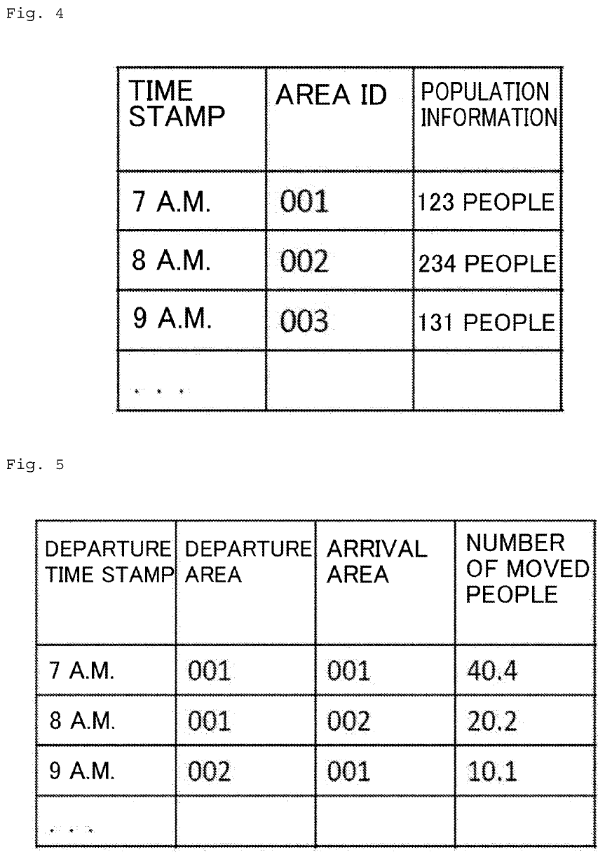

The area population data of each time point is stored in the data accumulation unit 110. Observation time points can be adopted at hourly intervals such as 7 a.m., 8 a.m., 9 a.m., . . . , for example. Also, areas are defined by dividing a geographical space in the manner of a 5 km square grid, for example, and IDs are given to the areas. FIG. 4 shows an example of the area population data of each time point.

The estimation control unit 120 acquires the area population data of each time point from the data accumulation unit 110. Then, the estimation control unit 120 gives the acquired area population data of each time point to the generation unit 130 and the second estimation unit 160.

Also, the estimation control unit 120 causes the generation unit 130, the first estimation unit 140, and the second estimation unit 160 to repeat each piece of processing until a condition determined in advance is satisfied. The condition determined in advance is, for example, “the likelihood has converged” or “the processing has been repeated a predetermined number of times”.

The generation unit 130 generates the problem (12) for estimating, with respect to each of the plurality of areas, the number of people who move from the area to each of the other areas at each observation time point based on the following two types of information. Here, first information of the two types of information indicates, with respect to each of the plurality of areas, the number of people who are present in the area at each observation time point. Second information of the two types of information indicates, with respect to each of the plurality of areas, probabilities of movement from the area to the other areas at each observation time point.

More specifically, the generation unit 130 first acquires currently estimated movement probabilities stored in the movement probability accumulation unit 170. Next, the generation unit 130 generates the problem (12) based on the area population data of each time point and the currently estimated movement probabilities. When the currently estimated movement probabilities are not available immediately after the processing is started, the generation unit 130 uses an initial value that is determined in advance. Then, the generation unit 130 gives the generated problem (12) to the first estimation unit 140.

The first estimation unit 140 estimates the number of moved people by solving the problem (12) generated by the generation unit 130, using a Sinkhorn-Knopp algorithm in which matrix operations are used. More specifically, all calculations of the algorithm 1 shown in FIG. 1 are written as matrix operations, and accordingly, the first estimation unit 140 estimates the number of moved people by solving the problem (12) through the matrix operations. Here, there are libraries for high-speed calculation of matrix operations. Python numpy library is an example of such a library. The first estimation unit 140 realizes high-speed estimation of the number of moved people by using such a library. The first estimation unit 140 can also use GPGPU (General-purpose computing on graphics processing units). The movement estimation device 10 can execute the matrix operations at a higher speed by further including GPGPU. Furthermore, the processing performed by the first estimation unit 140 can be easily performed in parallel. It takes a calculation time of O(|V|²) to perform a while loop that starts from row No. 2 in the algorithm 1 once, and a memory corresponding to O(|V|²) as a whole is prepared. Then, the first estimation unit 140 stores the estimated number of moved people in the number of moved people accumulation unit 150.

With respect to each of the plurality of areas for which estimation has been performed by the first estimation unit 140, the number of people moved from the area to each of the other areas at each observation time point is stored in the number of moved people accumulation unit 150. FIG. 5 shows, with respect to each of the plurality of areas for which estimation has been performed, an example of the number of people moved from the area to each of the other areas at each observation time point.

The second estimation unit 160 estimates movement probabilities based on the area population data of each time point and the number of moved people estimated by the first estimation unit 140. More specifically, the second estimation unit 160 first acquires the currently estimated number of moved people stored in the number of moved people accumulation unit 150. Next, the second estimation unit 160 estimates the probability of movement from an area to each of the other areas at each observation time point (the above formula (14)) based on the area population data of each time point and the number of moved people estimated by the first estimation unit 140. Then, the second estimation unit 160 stores the estimated movement probability in the movement probability accumulation unit 170.

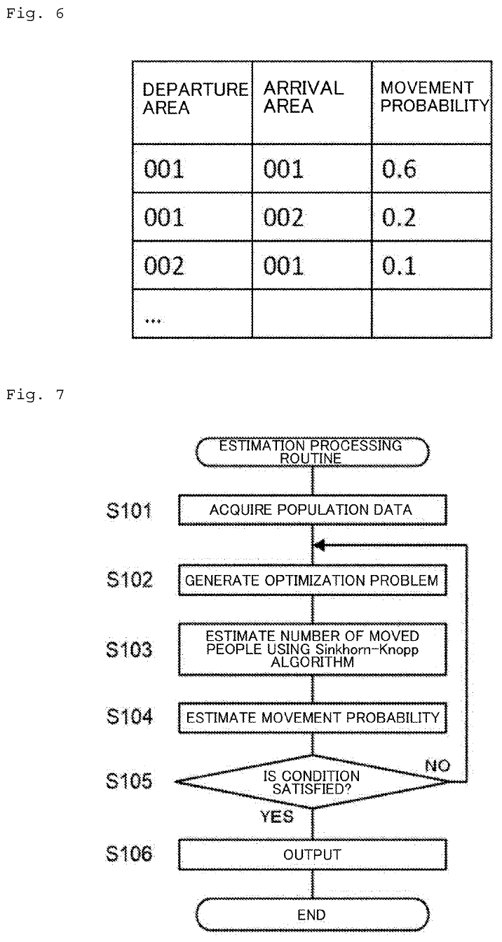

With respect to each of the plurality of areas for which estimation has been performed by the second estimation unit 160, probabilities of movement from the area to the other areas at each observation time point are stored in the movement probability accumulation unit 170. FIG. 6 shows, with respect to each of the plurality of areas for which estimation has been performed, an example of probabilities of movement from the area to the other areas at each observation time point.

The output unit 180 acquires, with respect to each of the plurality of areas, the number of people moved from the area to each of the other areas at each observation time point, from the number of moved people accumulation unit 150. Also, the output unit 180 acquires, with respect to each of the plurality of areas, probabilities of movement from the area to the other areas at each observation time point, from the movement probability accumulation unit 170. Then, the output unit 180 outputs the number of moved people and the probabilities of movement.

Function of Movement Estimation Device According to Embodiment of Technology of the Present Disclosure

Next, functions of the movement estimation device 10 will be described.

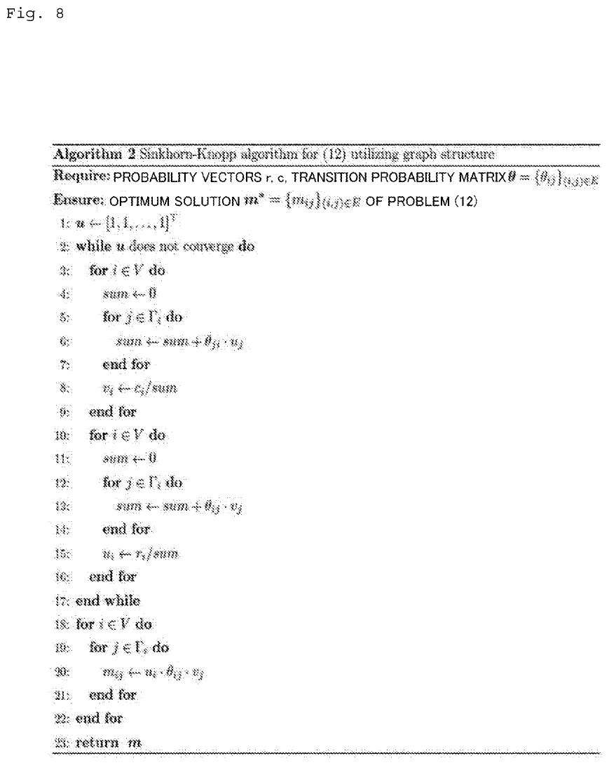

FIG. 7 is a flowchart showing a flow of a movement estimation processing routine performed by the movement estimation device 10. The movement estimation processing routine is performed by the CPU 11 by reading the movement estimation program from the ROM 12 or the storage 14, loading the program into the RAM 13, and executing the program.

In step S101, the CPU 11 functions as the estimation control unit 120 and acquires area population data of each time point from the data accumulation unit 110.

In step S102, the CPU 11 functions as the generation unit 130 and generates an optimization problem for estimating, with respect to each of the plurality of areas, the number of people moved from the area to each of the other areas at each observation time point based on the following two types of information. Here, first information of the two types of information indicates, with respect to each of the plurality of areas, the number of people who are present in the area at each observation time point. Second information of the two types of information indicates, with respect to each of the plurality of areas, probabilities of movement from the area to the other areas at each observation time point.

In step S103, the CPU 11 functions as the first estimation unit 140 and estimates the number of moved people by solving the optimization problem generated in the above step S102 using the Sinkhorn-Knopp algorithm in which matrix operations are used.

In step S104, the CPU 11 functions as the second estimation unit 160 and estimates movement probabilities based on the area population data of each time point and the number of moved people estimated in the above step S103.

In step S105, the CPU 11 functions as the estimation control unit 120 and determines whether or not a condition determined in advance is satisfied.

If the condition determined in advance is not satisfied (NO in the above step S105), the CPU 11 returns to step S102 and functions as the estimation control unit 120 to repeat the above steps S102 to S104.

On the other hand, if the condition determined in advance is satisfied (YES in the above step S105), the CPU 11 functions as the output unit 180 in step S106 and outputs the number of moved people estimated in the above step S103 and the movement probabilities estimated in the above step S104, and then ends the processing.

As described above, the movement estimation device according to the embodiment of the present disclosure generates an optimization problem for estimating, with respect to each of a plurality of areas, the number of observation targets that move from the area to each of the other areas at each observation time point, as the number of movements, based on observation values and movement probabilities, the observation values indicating, with respect to each of the plurality of areas, the number of observation targets that are present in the area at each observation time point, and the movement probabilities indicating, with respect to each of the plurality of areas, probabilities of movement from the area to the other areas at each observation time point, the movement estimation device estimates the number of movements by solving the generated optimization problem using a Sinkhorn-Knopp algorithm, estimates the movement probabilities based on the observation values and the estimated number of movements, and repeatedly performs generation of the optimization problem, estimation of the number of movements, and estimation of the movement probabilities until a condition determined in advance is satisfied. With use of the Sinkhorn-Knopp algorithm, M can be updated at a high speed. Also, the number of movements can be accurately estimated at a high speed through the entire processing.

In conventional technologies, a hyperparameter λ for controlling penalties needs to be set. However, there is a problem in that it is difficult to set the hyperparameter λ. That is, estimation accuracy largely varies depending on the setting of the hyperparameter λ, but unsupervised estimation is used in a problem for setting the hyperparameter λ, and accordingly, it is difficult to use a cross validation method or the like, and there is no effective measures for setting the parameter. In contrast, in the movement estimation device according to the embodiment of the present disclosure, constraints regarding conservation of the number of people can be handled as the constraints, rather than being incorporated into the objective function as penalty terms. Therefore, it is possible to perform estimation without determining the value of the hyperparameter λ.

The present disclosure is not limited to the above embodiment, and various alterations and applications can be made within a scope not departing from the gist of the present invention.

In the above embodiment, a case where the optimization problem is solved using a Sinkhorn-Knopp algorithm in which matrix operations are used is described as an example, but there is no limitation thereto. For example, a configuration is also possible in which the number of moved people is estimated by solving the optimization problem using a Sinkhorn-Knopp algorithm in which a graph structure is used. If the graph G=(V;E) is a sparse graph, i.e., if |E| of the graph is small, the present disclosure can be implemented more efficiently than in the case where merely the Sinkhorn-Knopp algorithm is used. Also, the memory can be saved if a matrix with a size of |V|×|V| is not held in an explicit manner and movement probabilities θ and the like are held in the form of an adjacency list or the like.

FIG. 8 shows an algorithm 2 of the case where the graph structure is used. The algorithm 2 is a pseudocode for solving the optimization problem using a Sinkhorn-Knopp algorithm in which the graph structure is used. When the algorithm 2 is used, the processing can be performed in parallel, but it is difficult to use GPGPU. When the present disclosure is implemented using the graph structure, it takes a calculation time of O(|E|) to perform the loop once, and a memory corresponding to O(|E|) is necessary. In an actual optimization problem, |E|=O(|V|) often holds true, and in such a case, a significant effect can be achieved by implementing the present disclosure using the graph structure.

As described above, in a case where the number of edges of the graph representing an adjacency relationship between areas is sufficiently small, if the number of moved people is estimated by solving the optimization problem using the Sinkhorn-Knopp algorithm in which the graph structure is used, M can be updated at a high speed with the calculation time and the memory being in proportion to the number of edges.

In the above embodiment, the observation targets are people and the number of movements is described as being the number of moved people, but there is no limitation thereto. The observation targets may also be animals or observation targets in computer simulation.

Note that the movement estimation program executed in the above embodiment as a result of the CPU reading software (program) may also be executed by various processors other than the CPU. Examples of processors used in such cases include a PLD (Programmable Logic Device) such as a FPGA (Field-Programmable Gate Array) of which a circuit configuration can be changed after production and a dedicated electrical circuit that is a processor including a circuit configuration such as an ASIC (Application Specific Integrated Circuit) that is designed to execute specific processing. Also, the movement estimation program may be executed by one of these various processors or a combination of two or more processors of the same type or different types (e.g., a combination of FPGAs or a combination of a CPU and a FPGA). More specifically, hardware structures of these various processors are electrical circuits that are obtained by combining circuit elements such as semiconductor elements.

In the above embodiment, a case where the movement estimation program is stored (installed) in the ROM 12 or the storage 14 in advance has been described, but there is no limitation thereto. The program may also be provided in a state where the program is stored in a non-transitory storage medium such as a CD-ROM (Compact Disk Read Only Memory), a DVD-ROM (Digital Versatile Disk Read Only Memory), or a USB (Universal Serial Bus) memory. The program may also be downloaded from an external device via a network.

Furthermore, the following supplementary notes are disclosed regarding the above embodiment.

Supplementary Note 1

A movement estimation device including:

a memory; and

at least one processor that is connected to the memory, wherein

the movement estimation device is configured to:

generate an optimization problem for estimating, with respect to each of a plurality of areas, the number of observation targets that move from the area to each of the other areas at each observation time point, as the number of movements, based on observation values and movement probabilities, the observation values indicating, with respect to each of the plurality of areas, the number of observation targets that are present in the area at each observation time point, and the movement probabilities indicating, with respect to each of the plurality of areas, probabilities of movement from the area to the other areas at each observation time point;

estimate the number of movements by solving the generated optimization problem using a Sinkhorn-Knopp algorithm;

estimate the movement probabilities based on the observation values and the estimated number of movements; and

repeat processing for generating the optimization problem, estimating the number of movements, and estimating the movement probabilities until a condition determined in advance is satisfied.

Supplementary Note 2

A non-transitory storage medium storing thereon a movement estimation program that causes a computer to:

generate an optimization problem for estimating, with respect to each of a plurality of areas, the number of observation targets that move from the area to each of the other areas at each observation time point, as the number of movements, based on observation values and movement probabilities, the observation values indicating, with respect to each of the plurality of areas, the number of observation targets that are present in the area at each observation time point, and the movement probabilities indicating, with respect to each of the plurality of areas, probabilities of movement from the area to the other areas at each observation time point;

estimate the number of movements by solving the generated optimization problem using a Sinkhorn-Knopp algorithm;

estimate the movement probabilities based on the observation values and the estimated number of movements; and

repeat processing for generating the optimization problem, estimating the number of movements, and estimating the movement probabilities until a condition determined in advance is satisfied.

### REFERENCE SIGNS LIST

10 Movement estimation device
11 CPU
12 ROM
13 RAM
14 Storage
15 Input unit
16 Display unit
17 Communication interface
19 Bus
100 Operation unit
110 Data accumulation unit
120 Estimation control unit
130 Generation unit
140 First estimation unit
150 Number of moved people accumulation unit
160 Second estimation unit
170 Movement probability accumulation unit
180 Output unit

1. A movement estimation device comprising:
a generation unit;
a first estimation unit;
a second estimation unit; and
an estimation control unit, wherein
the generation unit generates an optimization problem for estimating, with respect to each of a plurality of areas, the number of observation targets that move from the area to each of the other areas at each observation time point, as the number of movements, based on observation values and movement probabilities, the observation values indicating, with respect to each of the plurality of areas, the number of observation targets that are present in the area at each observation time point, and the movement probabilities indicating, with respect to each of the plurality of areas, probabilities of movement from the area to the other areas at each observation time point,
the first estimation unit estimates the number of movements by solving the optimization problem generated by the generation unit, using a Sinkhorn-Knopp algorithm,
the second estimation unit estimates the movement probabilities based on the observation values and the number of movements estimated by the first estimation unit, and
the estimation control unit repeats processing performed by the generation unit, the first estimation unit, and the second estimation unit until a condition determined in advance is satisfied.

2. The movement estimation device according to claim 1, wherein
the first estimation unit estimates the number of movements by solving the optimization problem generated by the generation unit, using a Sinkhorn-Knopp algorithm in which a matrix operation is used.

3. The movement estimation device according to claim 1, wherein
the first estimation unit estimates the number of movements by solving the optimization problem generated by the generation unit, using a Sinkhorn-Knopp algorithm in which a graph structure is used.

4. The movement estimation device according to any one of claims 1 to 3, wherein
the generation unit generates the optimization problem so as to correspond to a problem of finding Sinkhorn divergence.

5. A movement estimation method comprising:
generating, by a generation unit, an optimization problem for estimating, with respect to each of a plurality of areas, the number of observation targets that move from the area to each of the other areas at each observation time point, as the number of movements, based on observation values and movement probabilities, the observation values indicating, with respect to each of the plurality of areas, the number of observation targets that are present in the area at each observation time point, and the movement probabilities indicating, with respect to each of the plurality of areas, probabilities of movement from the area to the other areas at each observation time point;
estimating, by a first estimation unit, the number of movements by solving the optimization problem generated by the generation unit, using a Sinkhorn-Knopp algorithm;
estimating, by a second estimation unit, the movement probabilities based on the observation values and the number of movements estimated by the first estimation unit; and
repeating, by an estimation control unit, processing performed by the generation unit, the first estimation unit, and the second estimation unit until a condition determined in advance is satisfied.

6. A movement estimation program for causing a computer to execute processing that includes:
generating, by a generation unit, an optimization problem for estimating, with respect to each of a plurality of areas, the number of observation targets that move from the area to each of the other areas at each observation time point, as the number of movements, based on observation values and movement probabilities, the observation values indicating, with respect to each of the plurality of areas, the number of observation targets that are present in the area at each observation time point, and the movement probabilities indicating, with respect to each of the plurality of areas, probabilities of movement from the area to the other areas at each observation time point;
estimating, by a first estimation unit, the number of movements by solving the optimization problem generated by the generation unit, using a Sinkhorn-Knopp algorithm;
estimating, by a second estimation unit, the movement probabilities based on the observation values and the number of movements estimated by the first estimation unit; and
repeating, by an estimation control unit, processing performed by the generation unit, the first estimation unit, and the second estimation unit until a condition determined in advance is satisfied.
